(19) United States
(12) Patent Application Publication
(10) Pub. No.: US 2016/0031197 A1
(43) Pub. Date: Feb. 4, 2016

(54) METHOD OF ATTACHING A COMPOSITE MEMBER TO A STRUCTURE

(71) Applicant: BELL HELICOPTER TEXTRON INC., Hurst, TX (US)

(72) Inventors: Vance N. CRIBB, III, Grapevine, TX (US); Denver WHITWORTH, North Richland Hills, TX (US)

(73) Assignee: BELL HELICOPTER TEXTRON INC.

(21) Appl. No.: 14/819,194

(22) Filed: Aug. 5, 2015

Related U.S. Application Data
(63) Continuation-in-part of application No. 14/307,115, filed on Jun. 17, 2014, now Pat. No. 9,108,395.
Application No. 14/307,115 is a continuation of application No. 11/064,824, filed on Feb. 25, 2005, now Pat. No. 8,790,485.

(51) Int. Cl. B32B 37/00

(52) U.S. Cl. CPC B32B 37/003; B32B 2556/00; B32B 2605/18; B32B 2398/00; B32B 2305/07

(57) ABSTRACT

A method of attaching a composite member to a structure is provided. The method includes forming a laminate of fabric impregnated with resin; applying an adhesive to an area of the structure needing repair; positioning the impregnated laminated on the adhesive applied the area of the structure needing repair; applying a single vacuum enclosure over the laminate and the adhesive; applying heat at a first temperature to the impregnated laminate; applying a partial vacuum at a first vacuum pressure within the single vacuum enclosure to the impregnated laminate to degas the resin in the impregnated laminate and form a degassed laminate; and curing the degassed laminate and adhesive on the area of the structure needing repair by applying heat at a second temperature and by applying vacuum at a second vacuum pressure within the single vacuum enclosure, the second vacuum pressure greater than the first vacuum pressure.

### CROSS REFERENCE TO RELATED APPLICATIONS

This application is a Continuation-in-Part Application of U.S. patent application Ser. No. 14/307,115, filed on Jun. 17, 2014, which is a continuation of U.S. patent application Ser. No. 11/064,824, filed on Feb. 25, 2005 now U.S. Pat. No. 8,790,465 issued on Jul. 29, 2014, all of which are hereby incorporated by reference herein in their entirety.

### FIELD OF THE INVENTION

The present invention relates to the attachment of a laminate of fabric to a structure. In particular, illustrated embodiments of the present invention relate to providing fabric patches to composite structures, such as vehicles including helicopters.

### BACKGROUND

U.S. Pat. No. 5,442,156 to Westerman et al.: U.S. Pat. No. 5,595,692 to Folsom et al.: and U.S. Pat. No. 4,659,624 to Yeager et al. are examples of composite structures or repairs and each is incorporated herein by reference thereto in its entirety, respectively.

### SUMMARY OF THE INVENTION

An aspect of an embodiment of the invention is a method of attaching a composite member to a structure. The method includes forming a laminate of fabric impregnated with resin; applying an adhesive to an area of the structure needing repair; positioning the impregnated laminated on the adhesive applied the area of the structure needing repair; applying a single vacuum enclosure over the laminate and the adhesive; applying heat at a first temperature to the impregnated laminate; applying a partial vacuum at a first vacuum pressure within the single vacuum enclosure to the impregnated laminate to degas the resin in the impregnated laminate and form a degassed laminate; and curing the degassed laminate on the area of the structure needing repair by applying heat at a second temperature and by applying vacuum at a second vacuum pressure within the single vacuum enclosure, the second vacuum pressure greater than the first vacuum pressure.

In an embodiment of the present invention, the method further includes applying heat at a third temperature to cure the adhesive. In an embodiment, the third temperature is greater than or equal to the second temperature.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In an embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The accompanying drawings facilitate an understanding of the various embodiments of this invention. In such drawings:

FIG. 1A illustrates a method in accordance with an embodiment of the subject invention;

FIG. 1B illustrates a method in accordance with another embodiment of the subject invention;

FIG. 2A illustrates a method in accordance with another embodiment of the subject invention;

FIG. 2B illustrates a method in accordance with another embodiment of the subject invention;

FIG. 3A illustrates a method in accordance with yet another embodiment of the subject invention;

FIG. 3B illustrates a method in accordance with a further embodiment of the subject invention;

FIG. 4 illustrates an exploded view of a curing schematic in accordance with a further embodiment of the subject invention;

FIG. 5 illustrates a curing schematic in accordance with an embodiment of the subject invention; and

FIGS. 6-1 to 6-6 illustrate an embodiment of a repair process in accordance with an embodiment of the subject invention.

### DESCRIPTION OF ILLUSTRATED EMBODIMENTS

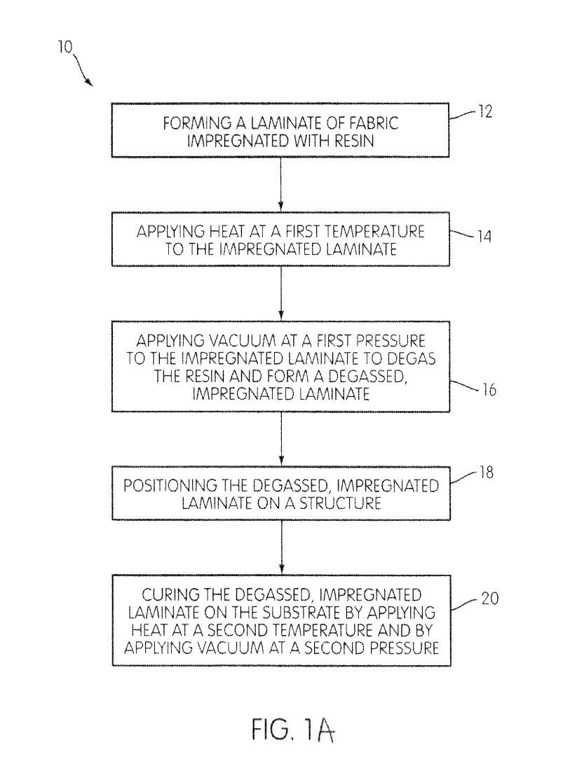

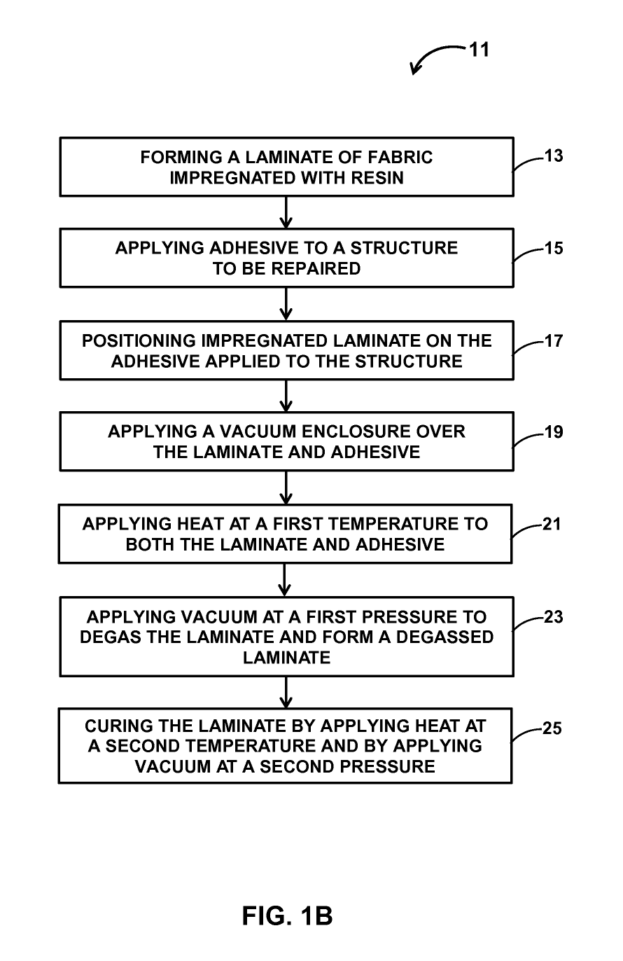

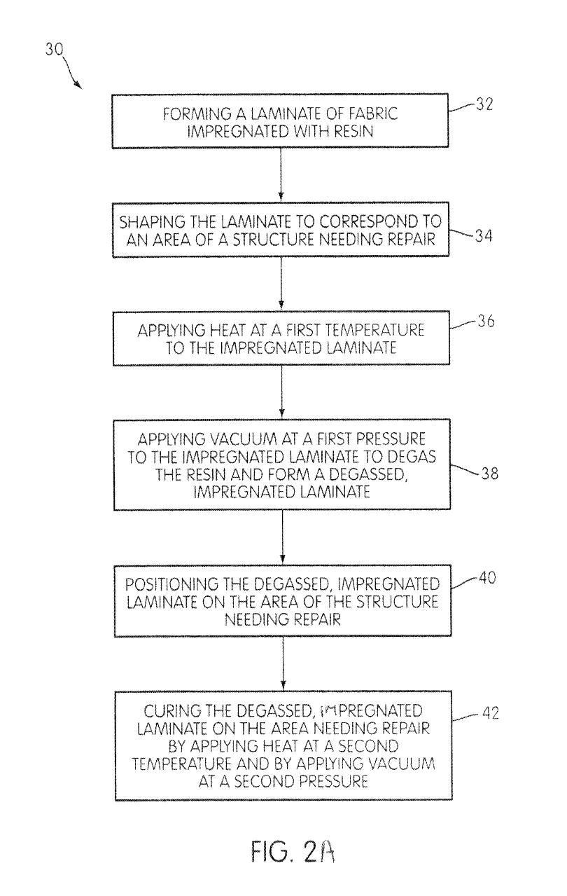

FIG. 1A illustrates an embodiment of the present invention. In particular, FIG. 1A illustrates a method 10 of attaching a composite member to a structure. The method includes forming a laminate of fabric impregnated with resin, at 12; applying heat at a first temperature to the impregnated laminate, at 14; applying vacuum at a first vacuum pressure to the impregnated laminate to degas the resin and form a degassed, impregnated laminate. at 16; positioning the degassed, impregnated laminate on a structure, at 18; and curing the degassed, impregnated laminate on the substrate by applying heat at a second temperature and by applying vacuum at a second vacuum pressure, at 20.

FIG. 1B illustrates another embodiment of the present invention. In particular, FIG. 1B illustrates a method 11 of attaching a composite member to a structure. The method includes forming a laminate of fabric impregnated with resin, at 13; applying an adhesive to a structure to be repaired, at 15; positioning or disposing the impregnated laminate on the adhesive applied to the structure, at 17; applying a vacuum enclosure (for example, a bagging material) over the laminate and adhesive (over an area of the structure needing repair), at 19; applying heat at a first temperature (e.g., between approximately 120 deg. F and approximately 130 deg. F) to the impregnated laminate, at 21; applying vacuum at a first vacuum pressure (e.g., between about 2 inch Hg and about 5 inch Hg) to the impregnated laminate to degas the resin and form a degassed laminate, at 23; and curing the laminate and the adhesive on the substrate by applying heat at a second temperature (e.g., about 225 deg. F) and by applying vacuum at a second vacuum pressure, at 25 (e.g., between about 25 inch Hg and about 28 inch Hg).

In an embodiment, the second vacuum pressure is greater than the first vacuum pressure. In an embodiment, the second temperature is dictated by the highest required temperature to cure both the adhesive and the laminate, i.e., the highest temperature of the temperature required to cure the adhesive and the temperature required to cure the laminate. In an embodiment, the second temperature is between about 200 deg. F and 350 deg. F. For example, if the temperature to cure the laminate is 200 deg. F and the temperature to cure the adhesive is 300 deg. F, then the second temperature to cure both the laminate and the adhesive is at least the highest of these two temperatures, i.e., in this example 300 deg. F.

In an embodiment, the impregnated laminate and the adhesive are cured substantially at the same time by applying heat at the second temperature and by applying vacuum at the second pressure, at 25. Full cure of the adhesive is usually defined as the point in which the total amount of reactive energy of the base material after being exposed to the time/temperature cycle is reduced to around 5-10% of the original available energy before it was heated.

In another embodiment, the method further includes applying heat at a third temperature (e.g., between about 200 deg. F and about 350 deg. F) to further cure the adhesive so as to adhere the laminate to the structure, at 27. In an embodiment, applying heat at the third temperature includes applying heat at a third temperature that is greater than or equal to the second temperature. In addition, in an embodiment, applying heat at a third temperature to cure the adhesive includes applying heat at a temperature greater than or equal to a curing temperature of the adhesive.

In an embodiment, the adhesive can be a structural adhesive film such as AF 163-2 adhesive made by 3M™ corporation, or FM 300-2 made by CYTEC™ corporation, or any other structural adhesive, a paste adhesive, a liquid adhesive, a solid adhesive, a powder adhesive, etc., or a combination of two or more of these adhesives. In an embodiment, applying the adhesive to the structure includes applying a layer of adhesive to an area of the structure needing repair. As it can be appreciated, applying the adhesive to the structure, at 15, can also be performed at the beginning of the method. For example, the application of the adhesive can be performed before forming the laminate of fabric impregnated with resin, at 13, but before positioning the laminate on the adhesive, at 17.

In an embodiment, positioning the impregnated laminate on the adhesive (e.g., structural film adhesive), at 17, includes contacting the impregnated laminate with the adhesive previously applied to the structure. In an embodiment, applying heat at the third temperature to cure the adhesive includes applying heat at a temperature greater than or equal to a curing temperature of the adhesive (e.g., greater than or equal to 200 deg. F).

The curing temperature of AF 163-2 structural film adhesive is approximately 225 deg. F (about 107 deg. C). In an embodiment, the curing time of AF 163-2 structural film adhesive is approximately 90 minutes when held at about 225 deg. F. The curing temperature of FM 300-2 structural film adhesive is approximately 250 deg. F (about 121 deg. C). FM 300-2 structural film adhesive can be processed at temperatures between about 250 deg. F and about 347 deg. F. For example, for FM 300-2M structural adhesive, manufactured by CYTEC, the cure cycle is an isothermal cure at 250 deg. F for about 30 minutes to about 90 minutes. In one embodiment, the film adhesive or adhesive layer (e.g., FM 300-2) is applied at a thickness in the range of about 0.005 inch to about 0.010 inch. In one embodiment, prior to applying the adhesive to the structure to be repaired, at 15, the surface of the structure at the area of the structure to be repaired is prepared for bonding by sanding or etching the surface of the structure and cleaning the surface of the structure. For example, by etching or sanding the surface of the structure to be repaired, a greater adhesion of the adhesive layer to the structure to be repaired or intimate contact of the adhesive to the structure to be repaired can be achieved.

The application of the adhesive to the surface of the structure to be repaired provides various benefits including performing a single stage to curing which provides time savings associated with not having to cool down the laminate, to remove the vacuum enclosure (e.g., bagging materials), and then to reapply the vacuum enclosure (bagging materials) for the final cure cycle (that is reheat, dwell and final cooling).

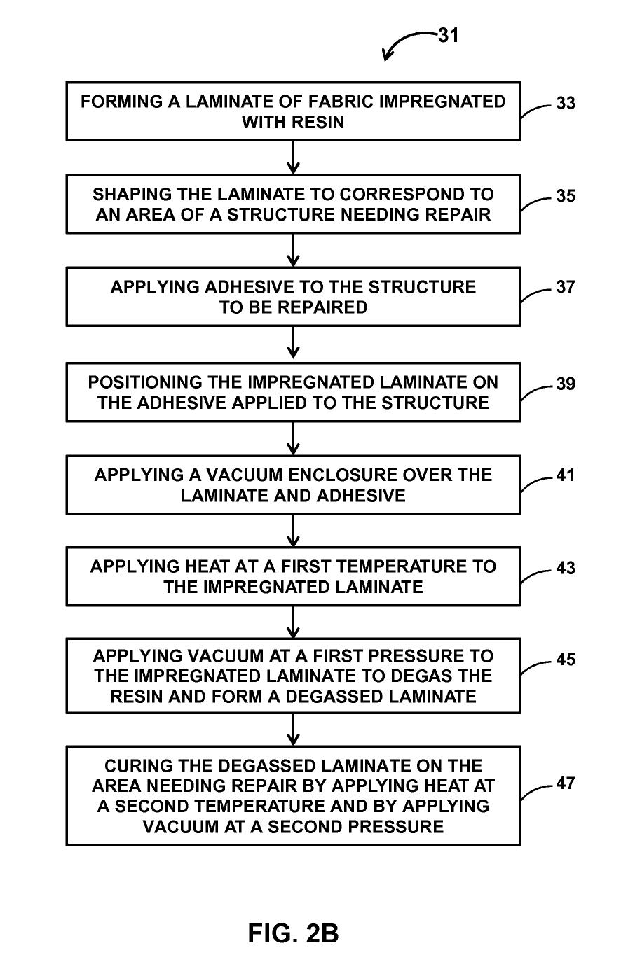

FIG. 2A illustrates another embodiment of the present invention. In particular. FIG. 2A illustrates a method 30 of attaching a composite patch to a structure to repair the structure, comprising: forming a laminate of fabric impregnated with resin 32; shaping the laminate to correspond to an area of a structure needing repair 34; applying heat at a first temperature to the impregnated laminate 36; applying vacuum at a first vacuum pressure to the impregnated laminate to degas the resin and form a degassed, impregnated laminate 38; positioning the degassed, impregnated laminate on the area of the structure needing repair 40; and curing the degassed, impregnated laminate on the area needing repair by applying heat at a second temperature and by applying vacuum at a second vacuum pressure 42.

FIG. 2B illustrates another embodiment of the present invention. In particular, FIG. 2B illustrates a method 31 of attaching a composite patch to a structure to repair the structure. The method includes forming a laminate of fabric impregnated with resin, at 33; shaping the laminate to correspond to an area of a structure needing repair, at 35; applying an adhesive to the structure to be repaired, at 37; positioning the impregnated laminate on the adhesive applied to the structure, at 39; applying a vacuum enclosure (e.g., bagging material) over the laminate and adhesive (over the area of the structure needing repair), at 41; applying heat at a first temperature (e.g., between approximately 120 deg. F and approximately 130 deg. F) to the impregnated laminate, at 43; applying vacuum at a first vacuum pressure (e.g., between about 2 inch Hg and about 5 inch Hg) to the impregnated laminate to degas the resin and form a degassed laminate, at 45; and curing the degassed laminate and the adhesive on the area of the structure needing repair by applying heat at a second temperature (e.g., about 225 deg. F) and by applying vacuum at a second vacuum pressure (e.g., between about 25 inch Hg and about 28 inch Hg), at 47. In an embodiment, the second vacuum pressure is greater than the first vacuum pressure.

In an embodiment, the second temperature is dictated by the highest required temperature to cure both the adhesive and the laminate, i.e., the highest temperature of the temperature required to cure the adhesive and the temperature required to cure the laminate. In an embodiment, the second temperature is between about 200 deg. F and 350 deg. F. For example, if the temperature to cure the laminate is 200 deg. F and the temperature to cure the adhesive is 300 deg. F, then the second temperature to cure both the laminate and the adhesive is at least the highest of these two temperatures, i.e., in this example 300 deg. F.

In an embodiment, the curing of the adhesive is accomplished at the same step of curing the laminate, at 47. That is, the impregnated laminate and the adhesive are cured substantially at the same time by applying heat at the second temperature and by applying vacuum at the second pressure, at 47.

In another embodiment, the method further includes applying heat at a third temperature (e.g., between about 200 deg. F and about 350 deg. F) to cure the adhesive. In an embodiment, applying heat at the third temperature includes applying heat at a third temperature that is greater than the second temperature.

Similar to the method illustrated in FIG. 1B, the applying of the adhesive, at 37, can be performed at any stage of the process 31, for example, after or before forming the laminate, at 33, after or before shaping the laminate at 35, but before positioning the laminate on the adhesive applied to the area of the structure needing repair, at 39. In an embodiment, applying heat at the third temperature includes applying heat at a third temperature that is greater than or equal to the second temperature. In addition, in an embodiment, applying heat at a third temperature to cure the adhesive includes applying heat at a temperature greater than or equal to a curing temperature of the adhesive.

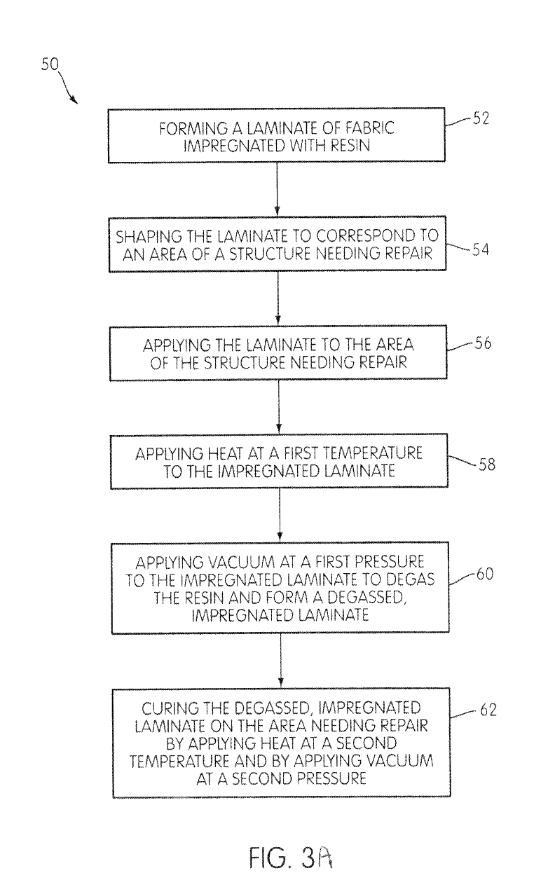

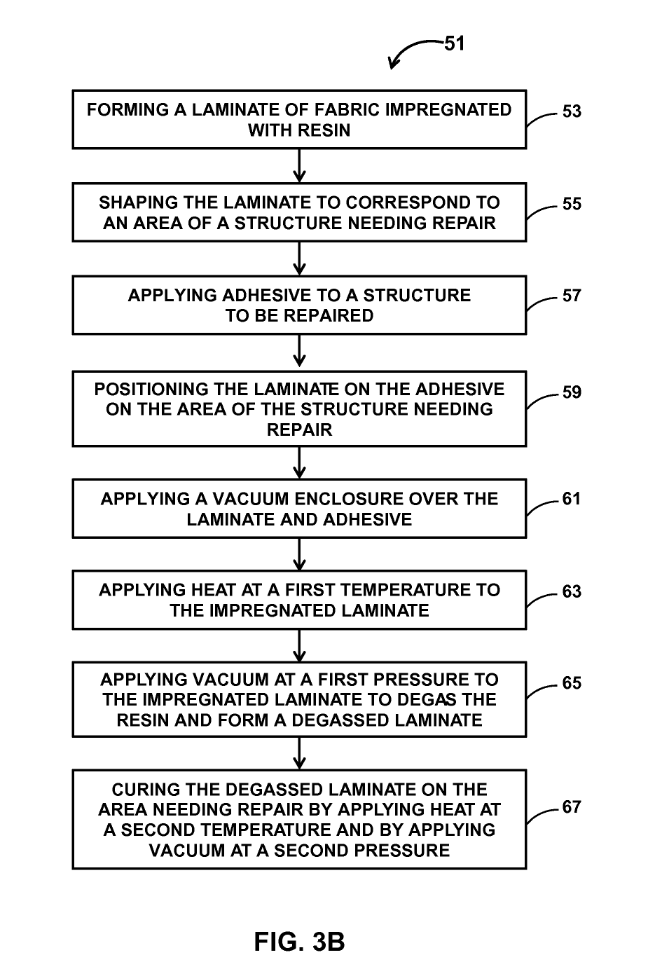

FIG. 3A illustrates a further embodiment of the present invention. In particular. FIG. 3A illustrates a method 50 of attaching a composite patch to a structure to repair the structure, comprising: forming a laminate of fabric impregnated with resin 52; shaping the laminate to correspond to an area of a structure needing repair 54; applying the laminate to the area of the structure needing repair 56; applying heat at a first temperature to the impregnated laminate 58; applying vacuum at a first vacuum pressure to the impregnated laminate to degas the resin and form a degassed, impregnated laminate 60; and curing the degassed, impregnated laminate on the area needing repair by applying heat at a second temperature and by applying vacuum at a second vacuum pressure 62.

FIG. 3B illustrates a further embodiment of the present invention. In particular, FIG. 3B illustrates a method 51 of attaching a composite patch to a structure to repair the structure. The method includes forming a laminate of fabric impregnated with resin, at 53; shaping the laminate to correspond to an area of the structure needing repair, at 55: applying adhesive to the area of the structure to be repaired, at 57; positioning the laminate on the adhesive on the area of the structure needing repair at 59; applying a vacuum enclosure over the laminate and adhesive, at 61; applying heat at a first temperature (e.g., between approximately 120 deg. F and approximately 130 deg. F) to the impregnated laminate at 63; applying vacuum at a first vacuum pressure (e.g., between about 2 inch Hg and about 5 inch Hg) to the impregnated laminate to degas the resin and form a degassed laminate at 65; and curing the degassed laminate on the area needing repair by applying heat at a second temperature (e.g., about 225 deg. F) and by applying vacuum at a second vacuum pressure (e.g., between about 25 inch Hg and about 28 inch Hg), at 67.

In an embodiment, the second vacuum pressure is greater than the first vacuum pressure. In an embodiment, the second temperature is dictated by the highest required temperature to cure both the adhesive and the laminate, i.e., the highest temperature of the temperature required to cure the adhesive and the temperature required to cure the laminate. In an embodiment, the second temperature is between about 200 deg. F and 350 deg. F. For example, if the temperature to cure the laminate is 200 deg. F and the temperature to cure the adhesive is 300 deg. F, then the second temperature to cure both the laminate and the adhesive is at least the highest of these two temperatures, i.e., in this example 300 deg. F.

In another embodiment, the method further includes applying heat at a third temperature (e.g., between about 200 deg. F and about 350 deg. F) to cure the adhesive. In an embodiment, applying heat at the third temperature includes applying heat at a third temperature that is greater than or equal to the second temperature. In an embodiment, applying heat at the third temperature includes applying heat at a temperature equal to or greater than a curing temperature of the adhesive. In another embodiment, the curing of the adhesive is accomplished at the same step of curing the laminate, at 67. That is, the impregnated laminate and the adhesive are cured substantially at the same time by applying heat at the second temperature and by applying vacuum at the second pressure, at 65.

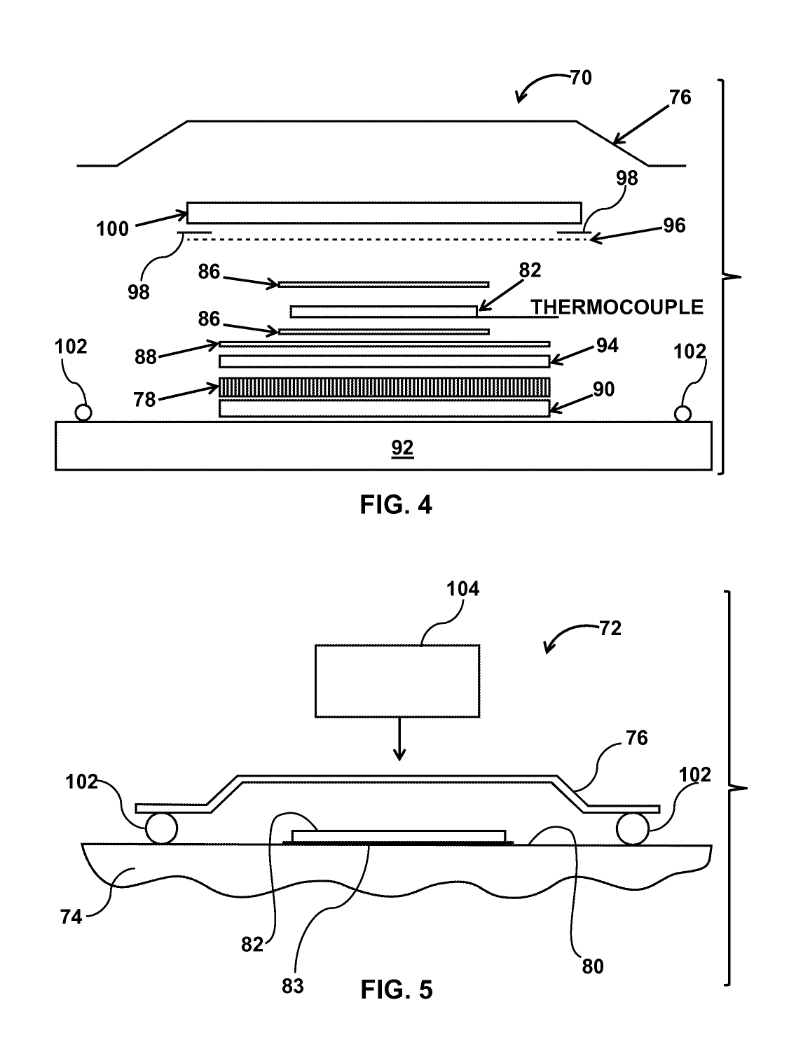

FIGS. 4 and 5 illustrate embodiments of tooling and materials that can be employed to carrying out a particular embodiment of the invention, such as, for example, the methods illustrated in FIGS. 1-3 and the particular embodiment of forming a repair patch as set forth in FIGS. 6-1 to 6-6. The assembly 70 in FIG. 4 and the assembly 72 in FIG. 5 relate to methods of repair or manufacture for a composite panel 74. In particular, the assembly 70 includes providing a vacuum device such as a vacuum bag 76 and a heating device such as a heater blanket 78 for an on-site repair wherein a debulking or degassing cycle 16, 23, 38, 45, 60, 65 is performed to a repaired area 80 of composite material utilizing vacuum and applied heat prior to the curing stage 20, 25, 42, 47, 62, 67 which includes the application of vacuum and heat, but at increased levels relative to the levels used during the degassing cycles 16, 23, 38, 45, 60, 65.

One aspect to achieving the high quality of repair in the embodiments is the use of a debulk cycle 16, 23, 38, 45, 60, 65 prior to the curing phase 20, 25, 42, 47, 62, 67 of the repair. This allows any volatiles generated by the resin to degas from the patch 82 before the resin and fabric are consolidated for curing. The result is a near void free, reproducible laminate 82 without clean room requirements or restrictions.

The embodiments described herein employ a curing step that debulks (degasses) the resin system under a low vacuum prior to applying full compaction (vacuum) pressure. Thus, a multi-step vacuum level combined with a multi-step temperature profile is one novel aspect of an embodiment of the present invention. Another novel aspect of an embodiment of the present invention is the application of an adhesive prior to applying or positioning the laminate on the area of the structure needing repair. A further novel aspect of an embodiment of the present invention is the curing of the adhesive and the laminate to provide adhesion of the laminate to the structure to ultimately achieve a repair patch that is securely attached to the structure.

The embodiments of FIGS. 4 and 5 produce an autoclave-quality composite repair capable of being installed on-site (e.g., at the vehicle being repaired) using only a single vacuum enclosure (e.g., a single vacuum bag) 76 and a heater blanket 78. Other previous methods have employed autoclaves or dedicated equipment that made the repair difficult to make on-site, such as, for example, a double vacuum debulk repair that uses dedicated tooling such as a rigid vacuum box. The assemblies 70 and 72 of the present invention, on the other hand merely use a collapsible vacuum bag 76 and a heating device such as blanket 78. In the past, the part 80 would have to be scrapped or removed and sent to a repair facility for autoclave processing.

The embodiments of the invention are capable of producing an autoclave-quality composite repair merely using a vacuum bag 76 and a heater blanket 78. The methods according to various embodiments of the present invention permit the tools and materials to be readily available and easily transported and the repair methods can be performed right on the structure to be repaired or in-situ, such as on-aircraft in the field while using room temperature storable materials (resin and fabric).

The methods according to various embodiments of the present invention permit repairs to be done on vehicles such as aircraft, at the aircraft's location. Additionally, repairs of structural parts are possible and since the laminates 82 of the embodiments are of autoclave quality, the thickness and weight required for any repair may be reduced. Further, the embodiments provide predictable laminate properties that can be calculated with a reproducible process and the embodiments are especially helpful with thick laminates.

The illustrated embodiments of FIGS. 4 and 5 may relate to the repair of composite parts for a vehicle or aircraft, such as a helicopter, or other structures utilizing high quality composites (e.g., fiberglass and graphite). In particular, the repair methods disclosed herein are intended for composite repairs requiring restoration of load bearing properties.

FIGS. 6-1 through 6-6 illustrate in detail a proposed repair process 84 in accordance with an embodiment of the invention. It should be understood that the process of FIGS. 6-1 through 6-6 is merely an embodiment of the various embodiments that may formulate a repair process embodiment in accordance with the invention.

Referring to FIGS. 4, 5 and 6-1 through 6-6, a method and assembly is illustrated in particular for application to a helicopter and further for repair of a structural composite part of a helicopter. In the repair process, a single patch 82 is formed to repair structure 74, which may a part of a helicopter. As stated in the repair process 84, templates are used to cut fabric, such as fiberglass or carbon fiber, in desired shapes to address the area 80 of structure 74 needing repair (Steps 7.1.1, 7.1.2). The fabric is impregnated with an appropriate resin and together the various layers of impregnated fabric are configured and stacked to form the appropriate laminate, which will form patch 82 (Step 7.3). The number of layers of fabric forming the laminate of patch 82 may vary depending on the specific structural requirements for each particular patch 82 application. For example, laminates having 4 to 24 layers of fabric may be used in some applications.

The impregnated laminate 82 is positioned between layers of porous material 86, such as porous Teflon and positioned on a nonporous layer 88, which is itself positioned on stack of items including a heater blanket 78 that is insulated by insulation 90 from base plate 92. A caul sheet 94 is positioned between the heater blanket 78 and the nonporous layer 88 (Steps 7.2). A perforated nonporous layer 96 is secured by tape 98 to the caul sheet 94 (Step 7.4.1). A breather layer 100 is positioned over the nonporous layer 96 and the vacuum bag 76 is sealed over the entire stacked assembly surrounding patch 82 and is secured in a substantially air-tight manner to base plate 92 by a sealing element such as sealant tape 102 (Step 7.4.6).

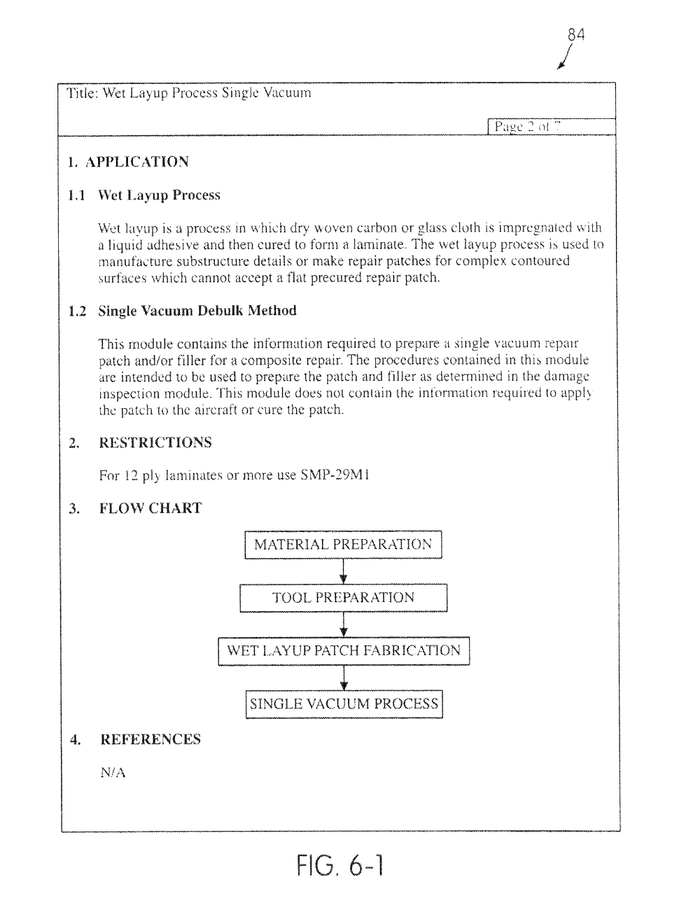

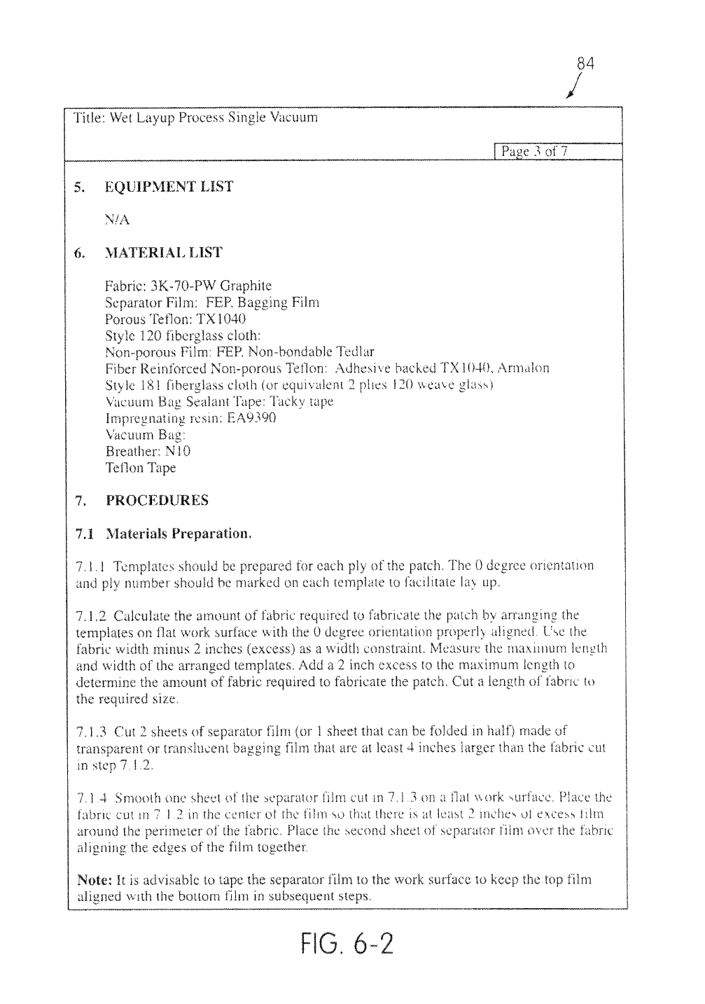

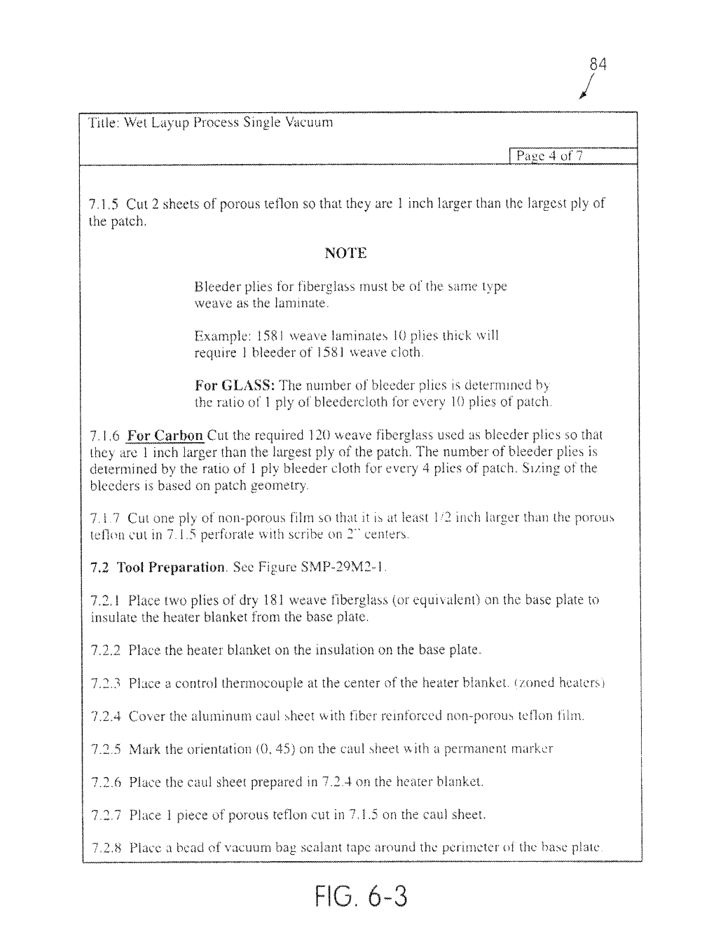

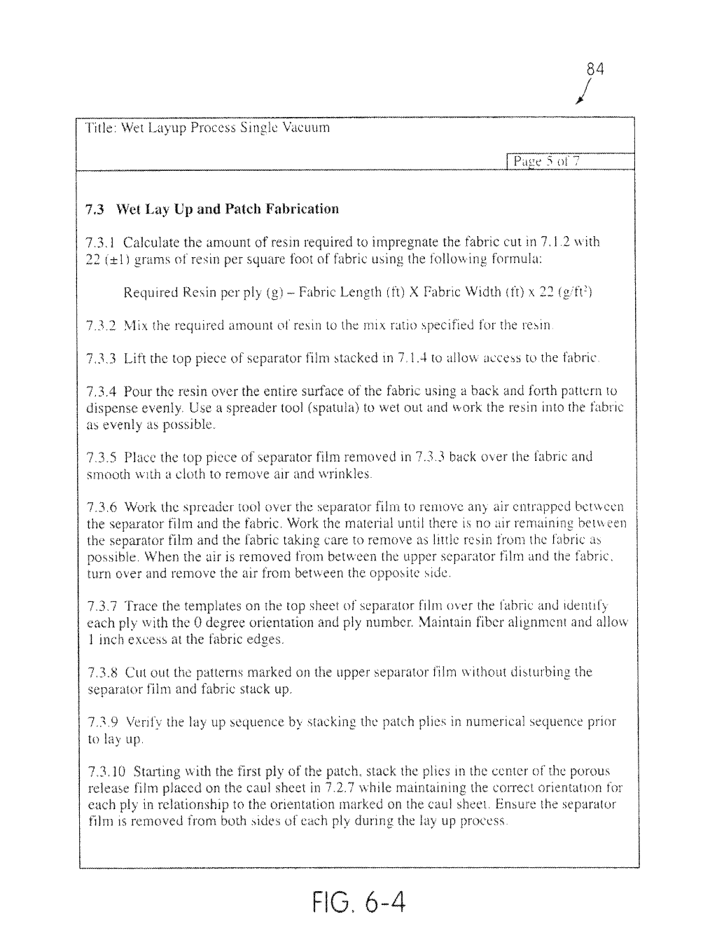

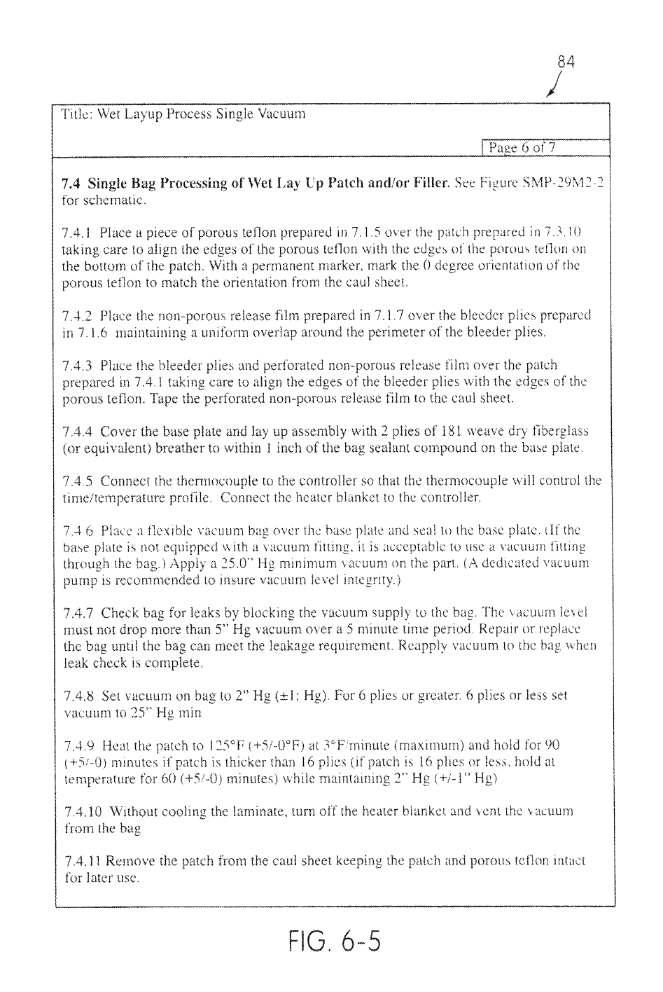

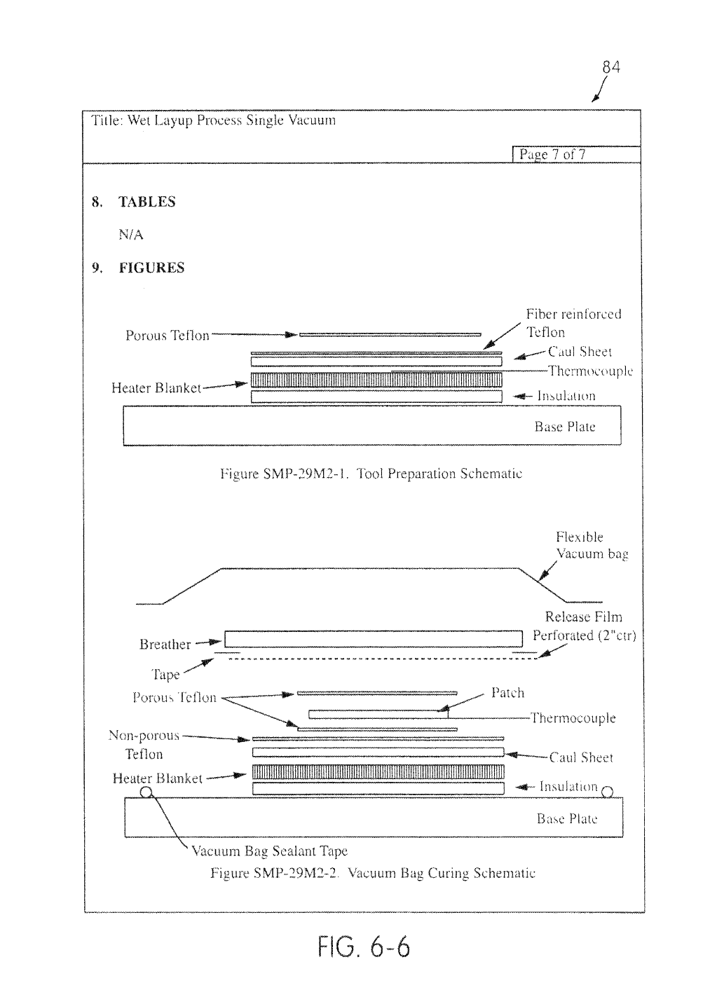

The heater blanket 78 is activated to heat patch 82 at a first temperature that is typically lower than the ultimate curing temperature (second temperature). As mentioned in Step 7.4.9 of FIG. 6-5, an example of a first temperature is approximately 125 degrees (F.) at a rate of approximately 3 degree (F.) a minute while holding for approximately 90 minutes if the patch is thicker than 16 plies, while a patch less than 16 plies would hold the temperature for approximately 60 minutes while maintaining approximately 2 in. of Hg. On the other hand, an example of a curing temperature (second temperature) may be approximately 200-250 degrees (F.) at a heat-up rate of approximately 2-8 degrees (F.) per minute.

At the same time as the first, degassing temperature is applied to patch 82, a vacuum is drawn to a desired vacuum pressure that is typically not as great as the vacuum pressure drawn for ultimate curing of the patch 82. As mentioned in Step 7.4.8 of FIG. 6-5, the vacuum bag 76 is configured to pull, through the use of conventional vacuum-forming apparatus, for example, approximately 2 inches of Hg for a patch 82 that is 6 plies or greater. Then, during curing, typically a vacuum pressure greater than that used during degassing will be employed to cure the patch 82. Thus, a greater vacuum force is used for ultimately curing the patch 82 on the structure 74 than is used initially during degassing of the patch 82.

The use of a vacuum and the application of heat on patch 82 acts to degas or debulk the patch and remove air including volatiles from the patch 82. This degassing, which results in the removing of volatiles from the patch 82, helps form an autoclave quality cure for patch 82.

Once the patch 82 has been heated and degassed sufficiently to remove air and other volatiles from the patch 82, the patch may be removed from the caul sheet 94 while remaining attached to the porous layers (Step. 7.4.11, FIG. 6-6), The patch 82 is then applied to the structure 74 as seen in FIG. 5 and vacuum pressure and heat is again applied to the patch 82 to cure the patch 82. As mentioned above, a greater amount of vacuum will be applied to the patch 82 as well as a higher degree of heat for the ultimate curing of patch 82 as seen in FIG. 5.

In an embodiment, prior to applying or placing the patch 82 on structure 74 needing repair, an adhesive layer 83 can be applied to or deposited on the structure 74. The patch (laminate) 82 can then be positioned on the adhesive layer 83 that is applied to the structure 74 so that the patch 82 is in contact with the adhesive layer 83.

The vacuum for the final curing may be provided by an appropriate vacuum-forming device or vacuum enclosure such as a vacuum bag 76 attached to a vacuum and the heat may be provided by a known heating device 104. The combination of degassing the patch 82 as described above with vacuum and heat and then curing the patch with vacuum and heat (and curing the adhesive) provide for a patch that is securely attached to the structure 74 to the extent that the patch 82 is of the quality of patches that are provided to structures via an autoclave.

In an embodiment, when using the adhesive layer 83, an additional step may be provided to ensure curing of the adhesive layer 83. The curing of the adhesive layer 83 is performed by applying heat at a temperature (a third temperature) to cure the adhesive layer 83. In an embodiment, the temperature for curing the adhesive layer 83 may be higher than the temperature for curing the patch 82. In which case, the temperature can be raised from the temperature for curing the patch 82 to the temperature for curing the adhesive and maintained at this level for predetermined time duration to achieve curing of the adhesive layer 83. The time duration and the temperature for curing the adhesive layer 83 depend on the type of adhesive that is used and are selected in accordance to the adhesive specification. For example, if the temperature for curing the patch is about 125 deg. F and the temperature for curing the adhesive is about 225 deg. F, heat may be applied to raise the temperature to the desired curing temperature of the adhesive of 225 deg. F and maintained for a proper period of time (e.g., 30 to 90 minutes) to ensure complete curing of the adhesive.

It should be understood that the specific amounts of vacuum and heat applied to cure the laminate will vary depending upon various factors, including the number and type of fabric layers, the type and amount of resin used in forming patch 82, and the other elements of the patch 82 and its application to the structure 74. Similarly, the amount of heat (i.e., temperature and/or time duration) applied to cure the adhesive can also vary depending on the thickness of the adhesive layer and/or the type of adhesive used. In one embodiment, the thickness of the adhesive layer is in the range between approximately 0.005 inch and approximately 0.010 inch.

Although FIG. 4 illustrates a situation where the patch is pre-formed and degassed on a base plate 92, e.g., for applications where a flat patch 82 is needed, the base plate 92 may be contoured to match any desired shape. Also, the patch 82 may be degassed while on the structure 74, for example, in situations where the patch 82 may be needed to take a unique contoured configuration consistent with a contour of the structure 74.

Also, although the more specific embodiments has described a composite patch 82 that is attached to a composite structure 74, such as portion of a helicopter, the degassing of a composite structure, such patch 82, to improve the quality of the patch 82 as described herein may be applied to any of the numerous situations outside of helicopters requiring such attachment of composite structures. For example, the methods herein are equally applicable to land or sea vehicle, especially those requiring repairs to structural members and those formed of composite materials.

Although the various steps of the method(s) are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A method of attaching a composite member to a structure, comprising:
forming a laminate of fabric impregnated with resin;
applying an adhesive to an area of the structure needing repair;
positioning the impregnated laminated on the adhesive applied the area of the structure needing repair;
applying a single vacuum enclosure over the laminate and the adhesive;
applying heat at a first temperature to the impregnated laminate;
applying a partial vacuum at a first vacuum pressure within the single vacuum enclosure to the impregnated laminate to degas the resin in the impregnated laminate and form a degassed laminate; and
curing the degassed laminate and the adhesive on the area of the structure needing repair by applying heat at a second temperature and by applying vacuum at a second vacuum pressure within the single vacuum enclosure, the second vacuum pressure greater than the first vacuum pressure.

2. The method according to claim 1, wherein curing the degassed laminate and the adhesive comprises applying heat at the second temperature that is at least the highest temperature of a temperature required to cure the adhesive and a temperature required to cure the laminate.

3. The method according to claim 1, further comprising applying heat at a third temperature to cure the adhesive.

4. The method according to claim 3, wherein applying heat at the third temperature to cure the adhesive comprises applying heat at a temperature greater than or equal to the second temperature.

5. The method according to claim 4, wherein applying heat at the third temperature comprises applying heat to raise a temperature from the second temperature to the third temperature and maintain the temperature at the third temperature for a period of time to cure the adhesive.

6. The method according to claim 3, wherein applying heat at the third temperature comprises applying heat at a temperature greater than or equal to a curing temperature of the adhesive.

7. The method according to claim 3, wherein applying heat at the third temperature comprises applying heat at a temperature greater than or equal to the curing temperature of the adhesive for a period of time.

8. The method according to claim 7, wherein applying heat at the temperature greater than or equal the curing temperature of the adhesive comprises applying heat at 225 deg. F or greater for a time period between approximately 30 minutes and approximately 90 minutes.

9. The method according to claim 1, wherein applying an adhesive to the structure comprises applying an adhesive selected from the group consisting of a structural adhesive, a paste adhesive, a liquid adhesive, a solid adhesive, and a powder adhesive.

10. The method according to claim 1, wherein applying heat at the first temperature to the impregnated laminate comprises applying heat to the impregnated laminate with a heat up rate during a period of time to reach the first temperature.

11. The method according to claim 1, wherein applying heat at the second temperature comprises applying heat at the second temperature that is greater than the first temperature.

12. The method according to claim 1, wherein the single vacuum enclosure consists of a single vacuum bag.

13. The method according to claim 1, wherein the structure comprises a structure of an aircraft.

14. The method according to claim 11, wherein the aircraft is a helicopter.

15. The method according to claim 1, further comprising shaping the impregnated laminate to correspond to the area of the structure needing repair.

16. The method according to claim 15, further comprising applying the impregnated laminate on the adhesive to the area of the structure needing repair, after shaping the impregnated laminate.

17. The method according to claim 1, wherein applying heat at the first temperature to the impregnated laminate comprises applying heat by positioning a heating device on or adjacent to the impregnated laminate.
